(19) United States
(12) Patent Application Publication
(10) Pub. No.: US 2019/0341003 A1
(43) Pub. Date: Nov. 7, 2019

(54) DISPLAY APPARATUS AND DISPLAY METHOD

(71) Applicant: CANON KABUSHIKI KAISHA, Tokyo (JP)

(72) Inventor: Kohei Inamura, Sagamihara-shi (JP)

(21) Appl. No.: 16/512,015

(22) Filed: Jul. 15, 2019

Related U.S. Application Data
(63) Continuation of application No. PCT/JP2017/044314, filed on Dec. 11, 2017.

(30) Foreign Application Priority Data
Jan. 16, 2017 (JP) 2017-005042
Oct. 18, 2017 (JP) 2017-201871

(51) Int. Cl. G09G 5/10; G09G 3/34; G09G 3/36; G09G 3/3208

(52) U.S. Cl. CPC G09G 5/10; G09G 3/342; G09G 3/36; G09G 2320/066; G09G 2320/0646; G09G 2330/023; G09G 2320/0606; G09G 3/3208

(57) ABSTRACT

A display apparatus includes: a setting unit configured to set a conversion characteristic for input image data; a correction unit configured to generate corrected image data by performing correction processing on the input image data in accordance with the conversion characteristic that is set; and a display panel configured to display an image based on the generated corrected image data, wherein the setting unit acquires a power related value, which is a value related to a power consumption of the display apparatus, based on the input image data and a first conversion characteristic that is set, and in a case where the acquired power related value is greater than a first threshold, the setting unit changes the setting to a second conversion characteristic of decreasing data brightness of the corrected image data, which corresponds to data brightness of the input image data that is higher than a second threshold.

### CROSS-REFERENCE TO RELATED APPLICATIONS

This application is a Continuation of International Patent Application No. PCT/JP2017/044314, filed Dec. 11, 2017, which claims the benefit of Japanese Patent Application No. 2017-005042, filed Jan. 16, 2017, and Japanese Patent Application No. 2017-201871, filed Oct. 18, 2017, which are hereby incorporated by reference herein in their entirety.

### BACKGROUND OF THE INVENTION

### Field of the Invention

The present invention relates to a display apparatus and a display method.

### Background Art

Development of display apparatuses having a wide dynamic range of display brightness (brightness of screen) is progressing. A wide dynamic range is called “high dynamic range (HDR)”. A display apparatus having a wide dynamic range of display brightness is hereafter called an “HDR display apparatus”. The HDR display apparatus can display data at a very high display brightness. However, if display is performed at a very high display brightness on the entire screen, the HDR display apparatus consumes a very large amount of power.

As a function to reduce power consumption of a display apparatus, the auto brightness limiter (ABL) function is known. With the ABL function, the display brightness is decreased on the entire screen when the average picture level (APL) of the image data is high. PTL 1 discloses an ABL function which limits the power consumption to a predetermined range.

However, some standard on the image data having HDR may specify a display brightness, so as to perform a display that accurately reproduces the specified display brightness. If the ABL function is used, however, the display brightness is decreased on the entire screen, and display at a preferable display brightness, such as the specified display brightness, cannot be maintained.

The present invention provides a technique to enable decreasing the power consumption of the display apparatus while maintaining display at a preferable display brightness.

### CITATION LIST

### Patent Literature

PTL 1 Japanese Patent Laid-Open No. 2002-32052

### SUMMARY OF THE INVENTION

The present invention in its first aspect provides a display apparatus comprising:
a display panel; and
at least one memory and at least one processor which function as:
   a setting unit configured to set a conversion characteristic for input image data; and
   a correction unit configured to generate corrected image data by performing correction processing on the input image data in accordance with the conversion characteristic that is set, wherein
the display panel displays an image based on the generated corrected image data, and
the setting unit acquires a power related value, which is a value related to a power consumption of the display apparatus, based on the input image data and a first conversion characteristic that is set, and in a case where the acquired power related value is greater than a first threshold, the setting unit changes the setting to a second conversion characteristic of decreasing data brightness of the corrected image data, which corresponds to data brightness of the input image data that is higher than a second threshold, from that in a case where the acquired power related value is smaller than the first threshold.

The present invention in its second aspect provides a display method comprising:
a setting step of setting a conversion characteristic for input image data;
a correction step of generating corrected image data by performing correction processing on the input image data in accordance with the conversion characteristic that is set; and
a display step of displaying an image based on the generated corrected image data, wherein
in the setting step, a power related value, which is a value related to a power consumption of the display apparatus, is acquired based on the input image data and a first conversion characteristic that is set, and in a case where the acquired power related value is greater than a first threshold, the setting is changed to a second conversion characteristic of decreasing data brightness of the corrected image data, which corresponds to data brightness of the input image data that is higher than a second threshold, from that in a case where the acquired power related value is smaller than the first threshold.

The present invention in its third aspect provides a non-transitory computer readable medium that stores a program, wherein
the program causes a computer to execute a display method comprising:
a setting step of setting a conversion characteristic for input image data;
a correction step of generating corrected image data by performing correction processing on the input image data in accordance with the conversion characteristic that is set; and
a display step of displaying an image based on the generated corrected image data, and
in the setting step, a power related value, which is a value related to a power consumption of the display apparatus, is acquired based on the input image data and a first conversion characteristic that is set, and in a case where the acquired power related value is greater than a first threshold, the setting is changed to a second conversion characteristic of decreasing data brightness of the corrected image data, which corresponds to data brightness of the input image data that is higher than a second threshold, from that in a case where the acquired power related value is smaller than the first threshold.

Further features of the present invention will become apparent from the following description of exemplary embodiments with reference to the attached drawings.

### BRIEF DESCRIPTION OF THE DRAWINGS

FIG. 1 is a block diagram depicting a configuration example of a display apparatus according to Example 1;

FIG. 2 is a flow chart depicting an operation example of the display apparatus according to Example 1;

FIG. 3A to FIG. 3C are graphs depicting examples of the brightness relationship according to Example 1;

FIG. 4 is a block diagram depicting a configuration example of a display apparatus according to Example 2;

FIG. 5 is a flow chart depicting an operation example of the display apparatus according to Example 2;

FIG. 6 is a diagram depicting an example of the brightness histogram according to Example 2;

FIG. 7 indicates an example of various parameters according to Example 2;

FIG. 8 is a block diagram depicting a configuration example of a display apparatus according to Example 3;

FIG. 9 is a block diagram depicting a configuration example of a display apparatus according to Example 4;

FIG. 10A and FIG. 10B are graphs depicting examples of the brightness relationship according to Example 4; and

FIG. 11A to FIG. 11C are diagrams depicting examples of a graphic image according to Example 4.

### DESCRIPTION OF THE EMBODIMENTS

### Example 1

Example 1 of the present invention will be described. In Example 1, a case of a transmission type liquid crystal apparatus will be described. The display apparatus according to Example 1, however, is not limited to a transmission type liquid crystal display apparatus. For example, a different display apparatus, constituted by a light-emitting unit and a display panel (modulation panel) which displays images on the screen by modulating (e.g. transmitting) light emitted from the light-emitting unit), may be used. In concrete terms, a micro-electro mechanical system (MEMS) shutter type display apparatus, which includes MEMS shutters as the display elements, a projector and the like may be used. Further, a self-emitting type display apparatus, such as an organic electro-luminescence (EL) display apparatus and a plasma display apparatus, may be used.

In Example 1, a case of the light-emitting unit (backlight unit) including a plurality of light source units will be described. In Example 1, the light emission brightness of each light source unit is independently controlled. This control is called “local dimming control”. By local dimming control, the contrast of the display image (image displayed on screen) can be improved.

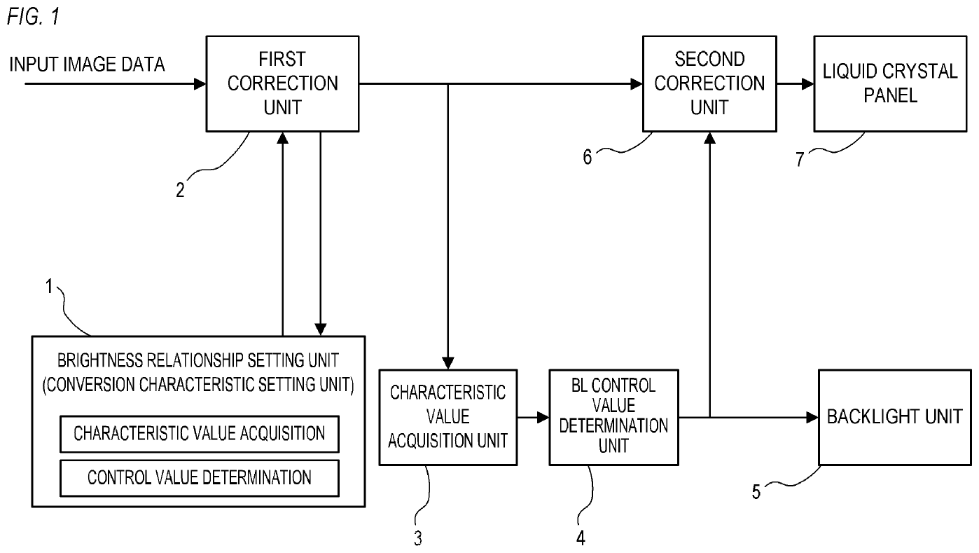

FIG. 1 is a block diagram depicting a configuration example of the display apparatus according to Example 1.

A brightness relationship setting unit (conversion characteristic setting unit) 1 sets brightness relationship (gradation conversion characteristic), which is a correspondence between the data brightness of the input image data and the display brightness of the display apparatus, for a first correction unit 2. The data brightness of the input image data is, for example, a “display brightness specified by a standard of the input image data”, a “brightness that was set in the input image data based on assumption”, or a “gradation value of the input image data”. The display brightness is the brightness on the screen. It may be regarded that the brightness relationship setting unit 1 sets the gradation conversion characteristic, which indicates the correspondence between the input gradation value and the output gradation value of the correction processing by the first correction unit 2.

In Example 1, based on the input image data and candidate relationship (gradation conversion characteristic candidate) which is a candidate of the brightness relationship (gradation conversion characteristic) used by the first correction unit 2, the brightness relationship setting unit 1 acquires a power related value, which is a value related to the power consumption of the display apparatus in the case when the candidate relationship is used as the brightness relationship. In Example 1, a backlight unit 5 emits light at a light emission brightness based on the input image data and the brightness relationship. In this case, a value based on the light emission brightness of the backlight unit 5 can be used as a power related value. In concrete terms, each of the plurality of light source units included in the backlight unit 5 emits light at an independent light emission brightness based on the input image data and the brightness relationship. In this case, the value based on a plurality of light emission brightness values, corresponding to the plurality of light source units respectively, can be used as the power related value. In Example 1, as the power related value, the brightness relationship setting unit 1 acquires a value based on the total of the plurality of light emission brightness values.

As the power related value, a value based a different light emission brightness value, such as the average of the plurality of light emission brightness values corresponding to the plurality of light source units respectively, may be acquired. A number of light source units, an arrangement of light source units and the like are not especially limited. For example, the plurality of light source units may be disposed in a matrix or in a checkerboard pattern. The number of light source units included in the backlight unit 5 may be one. In this case, a value based on the light emission brightness of the light source unit can be used as the power related value.

Then when the power consumption corresponding to a first candidate relationship (first gradation conversion characteristic candidate) is more than the power threshold, the brightness relationship setting unit 1 determines a second candidate relationship (second gradation conversion characteristic candidate) based on the acquired power related value. The second candidate relationship is a candidate relationship in which the power consumption is not more than the power threshold, and the correspondence in a range of the data brightness (data brightness of the input image data), which is not more than the brightness threshold (gradation threshold), is approximately the same as the first candidate relationship. The “power consumption corresponding to the candidate relationship (gradation conversion characteristic candidate)” may be regarded as the “power consumption of the display apparatus in the case where the candidate relationship (gradation conversion characteristic candidate) is used as the brightness relationship (gradation conversion characteristic) of the correction processing by the first correction unit 2”. The meaning of the phrase “approximately the same” includes “completely the same”.

In Example 1, when the power consumption corresponding to the first candidate relationship is not more than the power threshold, the brightness relationship setting unit 1 sets the first candidate relationship as the brightness relationship that is used by the first correction unit 2. When the power consumption corresponding to the first candidate relationship is more than the power threshold, on the other hand, the brightness relationship setting unit 1 sets the second candidate relationship as the brightness relationship that is used by the first correction unit 2. In concrete terms, when the power consumption corresponding to the first candidate relationship is not more than the power threshold, the brightness relationship setting unit 1 outputs a correction value that does not correct the first candidate relationship to the first correction unit 2. When the power consumption corresponding to the first candidate relationship is more than the power threshold, on the other hand, the brightness relationship setting unit 1 outputs a correction value that corrects the first candidate relationship to the second candidate relationship to the first correction unit 2. Other information (e.g. table, function) that indicates the candidate relationship to be used as the brightness relationship may be outputted to the first correction unit 2.

The brightness relationship (gradation conversion characteristic) and the correction value used by the brightness relationship setting unit 1 may be used for the brightness signal of the image data, or may be used for the R (red) signal, G (Green) signal and B (blue) signal of the image data respectively. The brightness relationship setting unit 1 may be configured to store a plurality of lookup tables (LUTs) corresponding to a plurality of candidate relationships (gradation conversion characteristic candidates) in advance, and select an LUT to be used. Further, the brightness relationship setting unit 1 may store a function corresponding to the brightness relationship (gradation conversion characteristic) in advance, and change the coefficient to be used by the function when required.

Based on the input image data and the brightness relationship, an image is displayed on the screen by the first correction unit 2, a characteristic value acquisition unit 3, a BL control value determination unit 4, the backlight unit 5, a second correction unit 6 and a liquid crystal panel 7.

The first correction unit 2 generates a corrected image data by correcting the input image data in accordance with the brightness relationship that is set by the brightness relationship setting unit 1. In concrete terms, the first correction unit 2 corrects the input image data so that display is performed in accordance with the brightness relationship. In Example 1, the first correction unit 2 corrects the input image data based on the correction value that is outputted from the brightness relationship setting unit 1 and the first candidate relationship. The correction performed by the first correction unit 2 is gamma correction, for example. It may be regarded that for each of the plurality of pixels (all pixels) of the input image data, the first correction unit 2 converts the gradation value of the pixel in accordance with the brightness relationship (gradation conversion characteristic) that is set.

For each of the plurality of light source units of the backlight unit 5, the characteristic value acquisition unit 3 acquires the characteristic value of the corrected image data generated by the first correction unit 2. In Example 1, each of the plurality of light source units corresponds to at least a part of the region (corresponding region) on the screen respectively. In concrete terms, the plurality of light source units correspond to a plurality of divided regions constituting the region of the entire screen respectively. For each of the plurality of light source units, the characteristic value acquisition unit 3 acquires the characteristic value of the corrected image data in the divided region (corresponding region) corresponding to this light source unit. In Example 1, a maximum value of a plurality of pixel values (gradation values) in the divided region is acquired as the characteristic value.

The arrangement of the corresponding regions, a number of corresponding regions, a shape of the corresponding region and the like are not especially limited. For example, the plurality of corresponding regions may be disposed in a matrix or in a checkerboard pattern. The arrangement of the corresponding regions may be the same as the arrangement of the light source units or may be different there from. The corresponding region may not be the divided region. A corresponding region may be distant from another corresponding region, or a part of a corresponding region may overlap with at least a part of other corresponding regions. The correspondence between the corresponding regions and the light source units may not be a one-to-one correspondence. For example, at least two light source units may correspond to one partial region. The entire region of the screen may correspond to one light source unit. The shape of the corresponding region may be a square, a triangle, a pentagon, a circle or the like.

The characteristic value is not limited to the maximum value of the pixel values. For example, other representative values (e.g. mean value, minimum value, median, mode) of the pixel values, a histogram of the pixel values, a representative value of the brightness values, a histogram of the brightness values and the like, may be acquired as the characteristic value.

The BL control value determination unit 4 determines a BL control value for each of the plurality of light source units respectively, in accordance with the characteristic value acquired by the characteristic value acquisition unit 3. The BL control value is a control value corresponding to the light emission brightness of the light source unit. For example, the BL control value determination unit 4 determines the BL control value of each light source unit, so that the light emission brightness of a light source unit corresponding to a divided region in which a bright image is displayed, is controlled to a light emission brightness that is higher than the light emission brightness of a light source unit corresponding to a divided region in which a dark image is displayed. The correspondence between the BL control value and the light emission brightness is not especially limited, but in Example 1, the BL control value is larger as the light emission brightness is higher.

The backlight unit 5 includes a plurality of light source units. Each of the plurality of light source units includes at least one light-emitting element. For the light-emitting element, a light-emitting diode, an organic EL element, a plasma element or a laser light source, for example, can be used. Each of the plurality of light source units emits light in accordance with the BL control value determined by the BL control value determination unit 4. In concrete terms, each of the plurality of light source units emits light at a light emission brightness in accordance with the BL control value.

The second correction unit 6 generates the display image data by further correcting the corrected image data based on each BL control value determined by the BL control value determination unit 4. In Example 1, the second correction unit 6 corrects the corrected image data so as to suppress the change of display brightness, which is caused by the change in the light emission brightness of each light source unit from a predetermined reference brightness. For example, the second correction unit 6 decreases the pixel values of the corrected image data (compression processing) for a region in which the light emission brightness of the light source unit is increased from the predetermined reference brightness, and increases the pixel values of the corrected image data (decompression processing) for a region in which the light emission brightness of the light source unit is decreased from the predetermined reference brightness. By correcting the pixel values of the corrected image data like this in accordance with the change in the light emission brightness of the light source unit, display gradation can be correctly displayed.

The liquid crystal panel 7 displays an image on the screen by transmitting light, which is emitted from the backlight unit 5, in accordance with the display image data generated by the second correction unit 6. In Example 1, the liquid crystal panel 7 increases a liquid crystal driver, a control board, and a plurality of liquid crystal elements. The control board controls the processing of the liquid crystal driver in accordance with the display image data. The liquid crystal driver drives each liquid crystal element in accordance with the instruction sent from the control board. Thereby the transmittance (aperture ratio; modulation rate) of each liquid crystal element is controlled to a value in accordance with the display image data. The light emitted from the backlight unit 5 transmits through each liquid crystal element, whereby an image is displayed on screen.

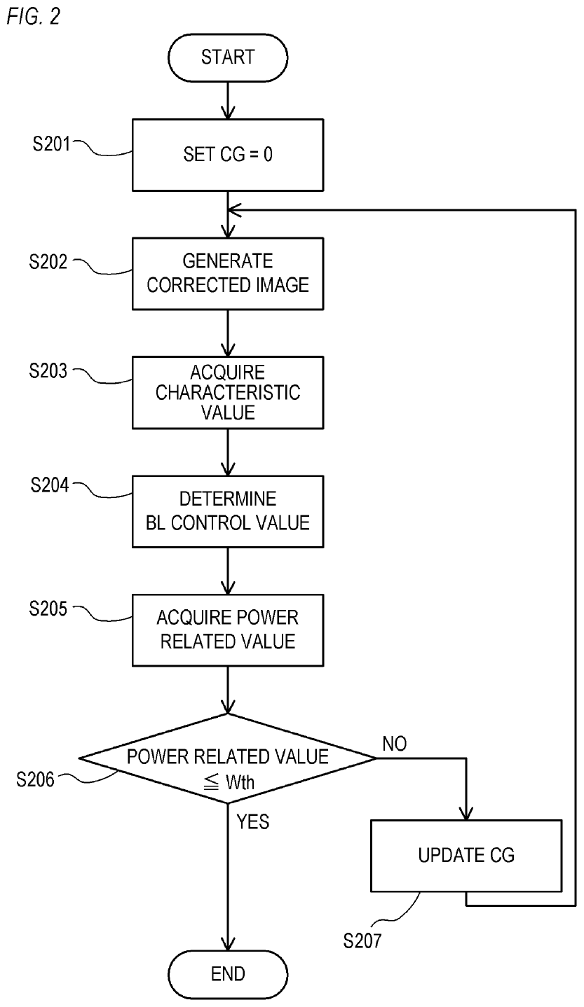

An operation example of the display apparatus according to Example 1 will be described next with reference to the flow chart in FIG. 2.

First in S201, a first candidate relationship is set as the brightness relationship. In concrete terms, the brightness relationship setting unit 1 sets the correction value CG=0.

Then in S202, the first correction unit 2 corrects the input image data in accordance with the brightness relationship which is set by the brightness relationship setting unit 1, whereby the corrected image data is generated. In concrete terms, the first correction unit 2 corrects each pixel value of the input image data using the following Expressions 1-1 and 1-2. In Expressions 1-1 and 1-2, “Lin” indicates the data brightness of the input image data. “Lout” indicates the data brightness of the corrected image data, and is the display brightness in accordance with the brightness relationship. “Lmax” indicates the upper limit of the data brightness of the input image data.

In the case of Lin≤Lmax−CG:Lout=Lin (Expression 1-1)

In the case of Lin>Lmax−CG:Lout=Lmax−CG (Expression 1-2)

According to Expressions 1-1 and 1-2, the data brightness Lin that is not more than Lmax−CG is not converted. In other words, the data brightness Lin that is not more than Lmax−CG is converted into the data brightness Lout that is the same as the data brightness Lin. The data brightness Lin that is more than Lmax−CG is converted into the data brightness Lout that is the same as Lmax−CG

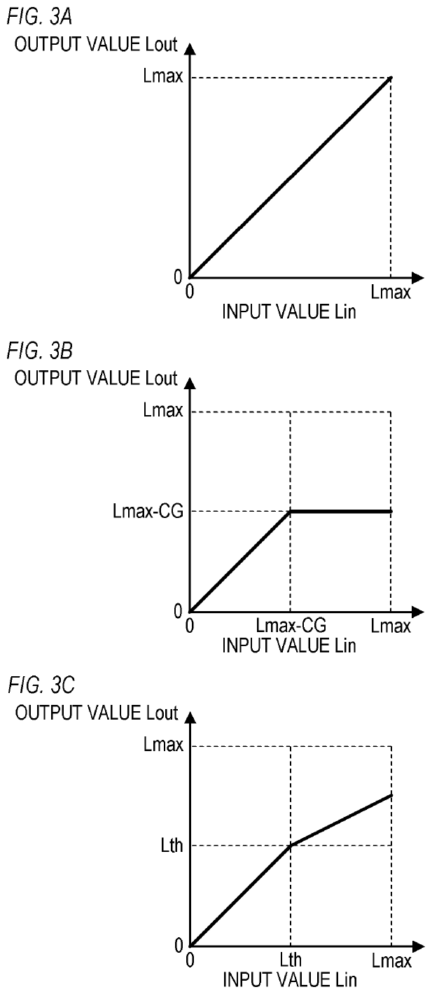

In the case of the correction value CG=0, the data brightness (input value) Lin is converted into the data brightness (output value) Lout in accordance with the conversion characteristic (first candidate relationship) in FIG. 3A. In the conversion characteristics in FIG. 3A, the data brightness Lout is approximately the same as the data brightness Lin corresponding to this data brightness Lout. The meaning of the phrase “approximately the same” includes “completely the same”. In the conversion characteristics in FIG. 3A, the data brightness Lout is completely the same as the data brightness Lin corresponding to this data brightness Lout. Therefore the phrase “correction value CG=0” may be regarded as the “correction value CG which does not correct the first candidate relationship”.

In the case of the correction value CG>0, the data brightness Lin is converted into the data brightness Lout in accordance with the conversion characteristic in FIG. 3B. In the conversion characteristic in FIG. 3B, the conversion characteristic of the data brightness Lin in the range that is not more than Lmax−CG is completely the same (approximately the same) as the conversion characteristic in FIG. 3A. Therefore the “Lmax−CG” may be regarded as the above mentioned “brightness threshold (gradation threshold)”. Further, in the range of the data brightness Lin that is more than Lmax−CG the conversion processing “to clip” the output value Lout to a predetermined value Lmax−CG (clip processing) is performed. In the conversion characteristic in FIG. 3B, the output value Lout in the range of the data brightness Lin (gradation range) that is more than Lmax−CG is decreased to a value (gradation value) that is less than the conversion characteristics in FIG. 3A.

The first candidate relationship is not limited to the conversion characteristic in FIG. 3A. For example, in the first candidate relationship, the display brightness (data brightness Lout) may be different from the data brightness Lin corresponding to this display brightness. For the first candidate relationship, a different candidate relationship, to implement display at an appropriate display brightness regardless the data brightness Lin, may be used. Further, in the case of CG>0, the correspondence (conversion characteristic) in the range of the data brightness Lin that is not more than Lmax−CG may not be completely the same as the first candidate relationship (conversion characteristic in FIG. 3A).

Then in S203, for each of the plurality of light source units, the brightness relationship setting unit 1 acquires the characteristic value of the corrected image data generated in S202. In Example 1, the brightness relationship setting unit 1 has a characteristic value acquisition function which executes the processing similar to the processing of the characteristic value acquisition unit 3. The processing in S203 is implemented by the characteristic value acquisition function of the brightness relationship setting unit 1. The processing that is executed by the characteristic value acquisition function of the brightness relationship setting unit 1 may or may not be completely the same as the processing of the characteristic value acquisition unit 3. For example, a simplified version of the processing of the characteristic value acquisition unit 3 may be executed by the characteristic value acquisition function of the brightness relationship setting unit 1. In Example 1, in the case of the correction value CG=0, the corrected image data is the same as the input image data. Therefore in the case of the correction value CG=0, the brightness relationship setting unit 1 may acquire the characteristic value from the input image data.

Then in S204, for each of the plurality of light source units, the brightness relationship setting unit 1 determines the BL control value in accordance with the characteristic value acquired in S203. In Example 1, the brightness relationship setting unit 1 has a control value determination function which executes the processing similar to the processing of the BL control value determination unit 4. The processing in S204 is implemented by the control value determination function of the brightness relationship setting unit 1. The processing that is executed by the control value determination processing function of the brightness relationship setting unit 1 may or may not be completely the same as the processing of the BL control value determination processing 4. For example, a simplified version of the processing of the BL control value determination unit 4 may be executed by the control value determination function of the brightness relationship setting unit 1.

Then in S205, the brightness relationship setting unit 1 acquires the power related value based on the plurality of BL control values determined in S204. In concrete terms, the brightness relationship setting unit 1 calculates the total of the plurality of BL control values as the power related value.

Then in S206, based on the power related value calculated in S205, the brightness relationship setting unit 1 determines whether the power consumption of the display apparatus is more than the power threshold. In Example 1, if the power related value calculated in S205 is more than the threshold Wth, the brightness relationship setting unit 1 determines that the power consumption of the display apparatus becomes more than the power threshold. If the power related value calculated in S205 is not more than the threshold Wth, on the other hand, the brightness relationship setting unit 1 determines that the power consumption of the display apparatus does not become more than the power threshold.

If it is determined that the power consumption of the display apparatus is more than the power threshold, this flow chart ends. If it is determined that the power consumption of the display apparatus becomes more than the power threshold, processing advances to S207.

In S207, the brightness relationship setting unit 1 updates the brightness relationship to a second candidate relationship, where the correspondence in a range of the data brightness Lin that is not more than the brightness threshold (nor more than the gradation threshold) is approximately the same as the first candidate relationship. In concrete terms, the brightness relationship setting unit 1 updates the correction value CG by adding an offset value ΔCG to the correction value CG Then processing returns to S202. As a result, the conversion characteristic indicated in FIG. 3B is used in S202, and the power related value corresponding to the second candidate relationship is acquired in S205. Then the processing in S202 to S207 are repeated until it is determined that the power consumption of the display apparatus does not become more than the power threshold. The “power related value corresponding to the candidate relationship (gradation conversion characteristic candidate)” may be regarded as the “value related to the power consumption of the display apparatus when the candidate relationship (gradation conversion characteristic candidate) is used as the brightness relationship (gradation conversion characteristic) of the correction processing by the first correction unit 2”. The “processing to add the offset value ΔCG to the correction value CG” may be regarded as the “processing to decrease the brightness threshold (gradation threshold)”.

According to the flow chart in FIG. 2, if the power consumption corresponding to the first candidate relationship is not more than the power threshold, processing does not advance to S207, and display is performed using the first candidate relationship as the brightness relationship. If the power consumption corresponding to the first candidate relationship is more than the power threshold, on the other hand, processing advances to S207, and the second candidate relationship is determined, then display is performed using the second candidate relationship as the brightness relationship.

In concrete terms, when a power related value that is not more than the threshold Wth is acquired as the power related value corresponding to the second candidate relationship which was initially determined, this second candidate relationship is determined as the brightness relationship that is used by the first correction unit 2. The “power related value that is not more than the threshold Wth” may be regarded as the “power related value related to the power consumption that is not more than the power threshold”. When a power related value that is more than the threshold Wth is acquired as the power related value corresponding to the second candidate relationship which was initially determined, the second candidate relationship is updated to a second candidate relationship in which the brightness threshold is further decreased, so that the power related value that is not more than the threshold Wth is acquired. In concrete terms, the processing to update the second candidate relationship to decrease the brightness threshold is repeated, until the power related value that is not more than the threshold Wth is acquired. The “power related value that is more than the threshold Wth” may be regarded as the “power related value related to the power consumption that is more than the power threshold”.

In Example 1, it is assumed that power is not outputted to the subsequent stage of the first correction unit 2 (characteristic value acquisition unit 3 and the second correction unit 6) until the second candidate relationship to acquire a power related value not more than the threshold Wth is determined. Thereby display can be performed at a power consumption that is not more than the power threshold. However, in the case of temporarily allowing display at a power consumption that is more than the power threshold, power may be outputted to the subsequent stage at the point when the second candidate relationship is updated. In this case, the flow chart in FIG. 2 is not applied to a single input image, but to a plurality of input images which are continuous in time. When the processing advances from S207 to S202, the corrected image generation step in S202 is applied to the input image that is later in time. In this case, instead of acquiring the characteristic value and determining the BL control value by the brightness relationship setting unit 1, the characteristic value may be acquired by the characteristic value acquisition unit 3 in the subsequent stage, and the BL control value may be acquired by the BL control value determination unit 4. In other words, the brightness relationship setting unit 1 may be configured to not include the characteristic value acquisition function and the control value determination function.

As described above, according to Example 1, when the power consumption corresponding to the first candidate relationship is more than the power threshold, the second candidate relationship is determined. This makes it possible to decrease the power consumption of the display apparatus to the power threshold or less, while maintaining the display at an appropriate display brightness. In concrete terms, in the second candidate relationship, the correspondence in the range of the data brightness Lin, that is not more than the brightness threshold, is approximately the same as the first candidate relationship. Therefore if the second candidate relationship is used, not only is the power consumption decreased, but also display at an approximately the same display brightness as the case of using the first candidate relationship can be implemented in a region where the data brightness Lin is not more than the brightness threshold. For example, in a region where the data brightness Lin is not more than the brightness threshold, display that accurately reproduces the display brightness specified by the standards on the input image data can be implemented.

The offset value ΔCG may or may not be a fixed value. For example, the offset value ΔCG may be changed in accordance with the difference between the power related value and the threshold Wth. In concrete terms, a greater offset value ΔCG may be set as the difference between the power related value and the threshold Wth is greater, so that the power consumption of the display apparatus is decreased to the power threshold or less by performing the processing in S202 to S207 only once. Further, the offset value ΔCG may be changed in accordance with an operation by a user for the display apparatus. Furthermore, the offset value ΔCG may be determined such that the second correction relationship is determined by performing the processing in S207 only once. In this case, the brightness relationship setting unit 1 may acquire the characteristic value from the input image data, instead of from the corrected image data generated by the first correction unit 2.

According to Example 1, the second candidate relationship is determined by determining the smaller brightness threshold as the power consumption corresponding to the first candidate relationship is higher. However, the method of determining the second candidate relationship is not limited to this. For example, the second candidate relationship may be determined by determining the smaller inclination of the change in the display brightness with respect to the change in the data brightness Lin that is more than the brightness threshold (more than the gradation threshold), as the power consumption corresponding to the first candidate relationship is higher. Further, the second candidate relationship may be determined by determining both the brightness threshold and the inclination, or the second candidate relationship may be determined by determining only one of the brightness threshold and the inclination.

In the case of determining the inclination, the data brightness Lin is converted into the data brightness Lout (gradation compression processing) in accordance with the conversion characteristics in FIG. 3C. In concrete terms, the first correction unit 2 corrects each pixel value of the input image data using the following Expressions 2-1 and 2-2. In Expressions 2-1 and 2-2, “Lth” indicates the brightness threshold. The correction value CG indicates the above mentioned inclination. The brightness relationship setting unit 1 determines a value that is at least 0 and not more than 1 as the correction value CG For example, in the case when the power consumption corresponding to the first candidate relationship is more than the power threshold, the brightness relationship setting unit 1 determines a value, which is smaller as the power consumption corresponding to the first candidate relationship is higher, as the correction value CG This inclination may be regarded as an inclination of the change in the output value (output gradation value) with respect to the change in the input value (input gradation value) that is more than the brightness threshold (gradation threshold).

In the case of Lin≤Lth:Lout=Lin (Expression 2-1)

In the case of Lin>Lth:Lout=CG×(Lin−Lth)+Lth (Expression 2-2)

According to the conversion characteristics in FIG. 3C, in a range of the data brightness Lin that is more than the brightness threshold Lth, the data brightness Lout increases when the data brightness Lin increases. Therefore in a region where the data brightness Lin is more than the brightness threshold, a brightness distribution representing the difference (change) of the data brightness Lin can be acquired, instead of a uniform brightness distribution.

The first candidate relationship is not limited to the candidate relationship (conversion characteristic) in FIG. 3A. For example, the display brightness (data brightness Lout) may increase linearly with respect to the increase of the data brightness Lin, or the display brightness (data brightness Lout) may increase non-linearly with respect to the increase of the data brightness Lin. Further, the first candidate relationship may include both a linear portion where the display brightness increases linearly with respect to the increase of the data brightness Lin, and a non-linear portion where the display brightness increases non-linearly with respect to the increase of the data brightness Lin.

The second candidate relationship is not limited to the candidate relationships (conversion characteristics) in FIG. 3B and FIG. 3C. The second candidate relationship may be any candidate relationship where the power consumption of the display apparatus is not more than the power threshold, and the correspondence in a range in which the data brightness Lin is not more than the brightness threshold is approximately the same as the first candidate relationship. In the case when the power consumption corresponding to the first candidate relationship is large, a value, which is greater than that of the case when the power consumption corresponding to the first candidate relationship is small, may be used as the brightness threshold. Further, in the case when the power consumption corresponding to the first candidate relationship is high, an inclination, which is larger than that of the case when the power consumption corresponding to the first candidate relationship is low, may be used as the above mentioned inclination. For the upper limit of the display brightness, a display brightness the same as the first candidate relationship may be used. In the range where the data brightness Lin is not more than the brightness threshold, the display brightness may increase linearly with respect to the increase of the data brightness Lin, or the display brightness may increase non-linearly with respect to the increase of the data brightness Lin. In the range where the data brightness Lin is more than the brightness threshold, the display brightness may increase linearly with respect to the increase of the data brightness Lin, or the display brightness may increase non-linearly with respect to the increase of the data brightness Lin. Further, the range of the data brightness Lin that is not more than the brightness threshold may include both the linear portion and the non-linear portion. The range of the data brightness Lin that is more than the brightness threshold may include the linear portion and the non-linear portion.

### Example 2

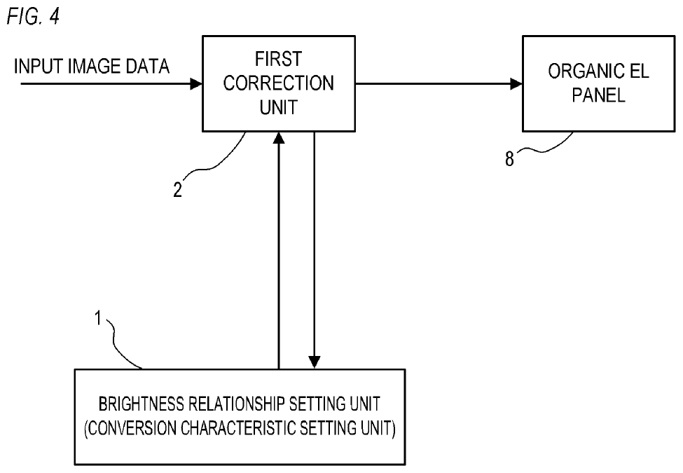

Example 2 of the present invention will be described. In Example 2, a case of an organic EL display apparatus will be described. In the following, aspects (configuration, processing, etc.) that are different from Example 1 will be described in detail, and aspects the same as Example 1 will be omitted. FIG. 4 is a block diagram depicting a configuration example of the display apparatus according to Example 2. In FIG. 4, a functional unit the same as Example 1 (FIG. 1) is denoted with the same reference sign as Example 1. In the example of FIG. 4, the corrected image data generated by the first correction unit 2 is used as the display image data. In concrete terms, the first correction unit 2 outputs the display image data (corrected image data) to an organic EL panel 8. The organic E1 panel 8 is a self-emitting display panel, which displays an image on the screen in accordance with the display image data.

In Example 2, the processing by the brightness relationship setting unit (conversion characteristic setting unit) 1 is different from Example 1. The power consumption of the display apparatus is approximately in proportion to the display brightness. When a self-emitting display panel is used, a value, based on a plurality of values of the display brightness (data brightness Lout), acquired by converting the plurality of values of the data brightness Lin corresponding to a plurality of pixels (all pixels) of the input image data, in accordance with the candidate relationship (gradation conversion characteristic candidate), can be used as the power related value. In Example 2, the brightness relationship setting unit 1 acquires a value, based on the total brightness value of a plurality of values of the data brightness Lout (a plurality of values of the data brightness Lout corresponding to a plurality of pixels (all pixels)) in accordance with the candidate relationship, as the power related value.

In concrete terms, for each of the plurality of pixels of the input image data, the first correction unit 2 converts the data brightness Lin of the pixel into the display brightness (data brightness Lout) in accordance with the brightness relationship (gradation conversion characteristic) that is set. This may be regarded that, for each of the plurality of pixels (all pixels) of the input image data, the first correction unit 2 converts the gradation value of the pixel into the display brightness in accordance with the brightness relationship (gradation conversion characteristic) that is set. Then the brightness relationship setting unit 1 acquires the data brightness Lout of each pixel, and acquires (generates) a brightness histogram based on the data brightness Lout of each pixel. In Example 2, a plurality the brightness category values, which correspond to a plurality of regions constituting a predetermined range of the data brightness Lout respectively, are determined in advance. In Example 2, n number of integers (from 1 to n) are determined in advance as the plurality of the brightness category values, and the brightness category value is greater as the data brightness Lout is higher. For each of the plurality of category values, the processing to acquire the brightness histogram counts a number (frequency) of pixels which have the data brightness Lout of the brightness category value.

Then the brightness relationship setting unit 1 calculates the power related value TW using the following Expression 3. In Expression 3, Ct(x) indicates the frequency Ct of the brightness category value x (x is an integer of at least 1 and not more than n). According to Expression 3, the total of a plurality of frequencies Ct(x) values, which correspond to a plurality of brightness category values x respectively, is calculated as the power related value TW.

TW=1×Ct(1)+2×Ct(2) . . . +(n−1)×Ct(n—1)+n×Ct(n) (Expression 3)

A number of brightness category values is not especially limited. The correspondence between the brightness category value and the data brightness Lout is not especially limited either. For example, the brightness category value may be smaller as the data brightness Lout is higher. The plurality of values of the data brightness Lout may or may not belong to the range corresponding to the brightness category value. One value of the data brightness Lout may belong to a range corresponding to the brightness category value. The value of the data brightness Lout may be used as the brightness category value. The above mentioned predetermined range is not especially limited either. For example, the range of the data brightness Lout acquired in the first candidate relationship may be used as the predetermined range.

The value based on different display brightness values, such as an average brightness value of a plurality of the display brightness values in accordance with the candidate relationship, may be acquired as the power related value. The average brightness level (average pixel level: APL) of the image data may be acquired as the power related value. Further, in the case when the light-emitting unit emits light at the higher light emission brightness as the data brightness Lin is higher, in a display apparatus which includes the light-emitting unit and the modulation panel, as well, a value based on a plurality of the display brightness values in accordance with the candidate relationship may be used as the power related value.

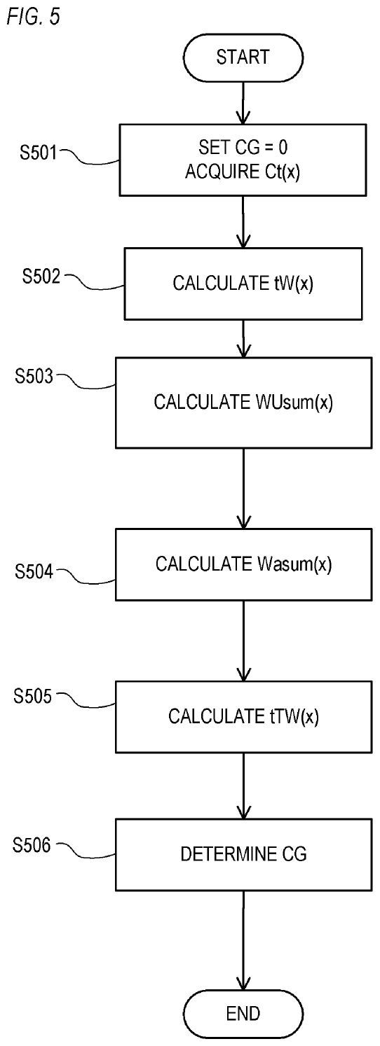

An example of a method of determining the brightness relationship (correction value CG) according to Example 2 will be described with reference to the flow chart in FIG. 5. In Example 2, a case of determining a value, which determines the brightness threshold (gradation threshold), as the correction value CG, will be described. In concrete terms, a case of determining the correction value CG used for Expressions 1-1 and 1-2 and determining the conversion characteristics indicated in FIG. 3A and FIG. 3B as the brightness relationships will be described.

First in S501, the brightness relationship setting unit 1 sets a first candidate relationship as the brightness relationship, and acquires a brightness histogram (characteristic value) corresponding to the first candidate relationship. In concrete terms, the brightness relationship setting unit 1 sets the correction value CG=0, and acquires the data brightness Lout corresponding to the conversion characteristic in FIG. 3A as the data brightness Lout of each pixel. Then for each of the plurality of brightness category values x, the brightness relationship setting unit 1 counts a number of pixels (frequency Ct(x)) having the data brightness Lout of this brightness category value x.

Then in S502, for each of the plurality of brightness category values x, the brightness relationship setting unit 1 determines the power related value tW(x) related to the power consumption that is required to display the pixel corresponding to the brightness category value x. In concrete terms, the brightness relationship setting unit 1 calculates the power related value tW(x) by multiplying the brightness category value x by the frequency Ct(x). The power related value tW(x) is a value tW corresponding to this brightness category value x. The power related value tW(x) is also a value that is determined when the first candidate relationship is used as the brightness relationship.

Then in S503, for each of the plurality of brightness category values x, the brightness relationship setting unit 1 calculates the total WUsum(x) of the power related values tW of brightness category values which are smaller than this brightness category value x. In concrete terms, the brightness relationship setting unit 1 calculates the power related value (total) WUsum(x) using the following Expressions 4-1 and 4-2. The power related values WUsum(x) is a value WUsum corresponding to the brightness category value x. The “power related value WUsum(x)” may be regarded as the “power consumption required to display the pixels corresponding to the brightness category values which are smaller than this brightness category value x”. The power related value WUsum(x) is also a value that is determined when the first candidate relationship is used as the brightness relationship.

$$\begin{matrix}[ Math . 1 ] & \\ If x = 1 \text{:} WUsum ( x ) = 0 & ( Expression 4 \text{-} 1 ) \\ If x \geq 2 \text{:} WUsum ( x ) = {\sum }_{i = 1}^{x - 1} tW ( i ) & ( Expression 4 \text{-} 2 )\end{matrix}$$

Then in S504, for each of the plurality of brightness category values x, the brightness relationship setting unit 1 determines the power related value Wasum(x) based on the assumption that brightness category values greater than this brightness category value x were equal to this brightness category value x. The power related value Wasum(x) is a value Wasum related to the power consumption that is required to display a pixel corresponding to this brightness category value x.

Then in S505, for each of the plurality of brightness category values x, the brightness relationship setting unit 1 calculates the total tTW(x) of the power related value WUsum(x) and the power related value Wasum(x). The power related value (total) tTW(x) is a value tTW corresponding to this brightness category value x. By the processing in S505, a plurality of the power related values TW, which correspond to the plurality of candidate relationships respectively, are acquired. Here in each of the plurality of candidate relationships, the correspondence in the range of the data brightness Lin, that is not more than the brightness threshold, is approximately the same as the first candidate relationship. In Example 2, in the candidate relationship corresponding to the power related value tTW(x), the brightness threshold corresponds to the brightness category value x. In concrete terms, in the candidate relationship corresponding to the power related value tTW(x), the brightness threshold is equal to the data brightness Lout of the brightness category value x.

Then in S506, based on the plurality of power related values tTW(x), the brightness relationship setting unit 1 determines one of the plurality of candidate relationships, which correspond to the plurality of power related values tTW(x) respectively, as the brightness relationship. In concrete terms, the brightness relationship setting unit 1 determines the correction value CG, so that a brightness threshold, corresponding to the brightness category value x of the power related value tTW(X) that is not more than the threshold Wth, is set. If at least two power related values tTW(x) that are not more than the threshold Wth are acquired, the brightness relationship setting unit 1 determines the correction value CG, so that a brightness threshold corresponding to the brightness category value x of the maximum value of at least two power related values tTW(x) is set.

In Example 2, the power consumption of the display apparatus can be decreased to the power threshold or less by using the candidate relationship, in which the power related value tTW(x) is not more than the threshold Wth, as the brightness relationship. Therefore according to the processing in S506, the candidate relationship, in which the power consumption related to the power related value tTW(x) is not more than the power threshold, is determined as the brightness relationship. In some cases, the power related value tTW(x) related to the power consumption, that is not more than the power threshold, may be acquired for at least two candidate relationships out of the plurality of candidate relationships. In this case, a candidate relationship of which power consumption related to the power related value tTW(x) is highest, out of at least two candidate relationships, is determined as the brightness relationship.

If the power related value tTW(n) is not more than the threshold Wth, the first candidate relationship indicated in FIG. 3A is determined as the brightness relationship. If the power related value tTW(n) is more than the threshold Wth, the second candidate relationship indicated in FIG. 3B is determined as the brightness relationship.

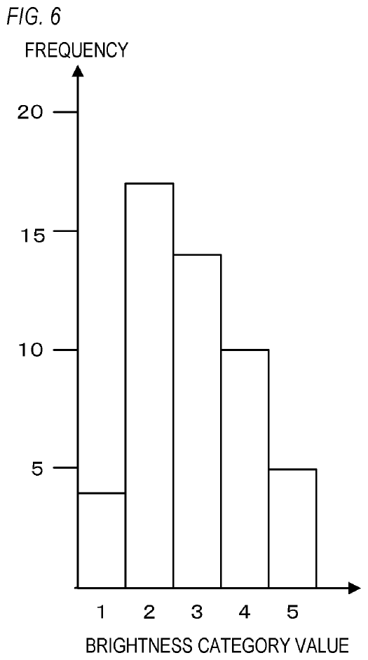

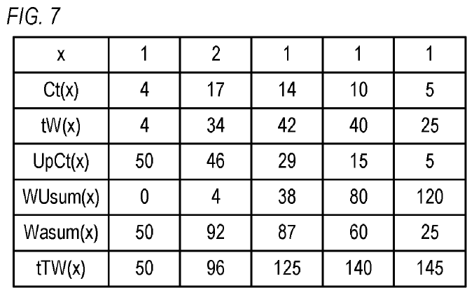

Concrete examples of the method of determining the correction value CG will be described next with reference to FIG. 6 and FIG. 7. To simplify description, in this example, the brightness category values x have five levels of values, 1 to 5, and the input image data has 10 pixels in the horizontal direction×five pixels in the vertical direction in total of 50 pixels. The power consumption of the display apparatus is at the maximum when all pixels correspond to the brightness category value x=5. According to Expression 3, the power related value TW (power consumption of the display apparatus) is 250 at the maximum. Here an example, when 125, which is half this maximum value of 250, is used as the threshold Wth, will be described.

First in S501, the brightness histogram in FIG. 6 is acquired. In concrete terms, the frequency Ct(x) in FIG. 7 is acquired. Then in S502, the power related value Tw(x) in FIG. 7 is calculated. For example, the frequency Ct(3) of the brightness category value x=3 is 14, hence 3×14=42 is calculated as the power related value tW(3). The power related values tW(1), tW(2), tW(4) and tW(5) are also calculated in the same manner.

Then in S503, the power related value WUsum(x) in FIG. 7 is calculated. For example, brightness category values less than the brightness category value x=1 do not exist. Therefore 0 is calculated as the power related value WUsum(1). Brightness category values less than the brightness category value x=4 are three brightness category values x=1, 2 and 3. The power related value tW(1) of the brightness category value x=1 is 4, the power related value tW(2) of the brightness category value x=2 is 34, and the power related value tW(3) of the brightness category value x=3 is 42. Hence 4+34+42=80 is calculated as the power related value WUsum(4). The power related value WUsum(2), WUsum(3) and WUsum(5) are also calculated in the same manner.

Then in S504, the power related value Wasum(x) in FIG. 7 is calculated. In FIG. 7, “UpCt(x)” is a number (frequency) of pixels corresponding to the brightness category values that are more than the brightness category value x. For example, the frequency Ct(1) of the brightness category value x=1 is 4, and the frequency Ct(2) of the brightness category value x=2 is 17. Hence the frequency UpCt(3) of the brightness category value X=3 is 50−4−17=29. As a result, 3×29=87 is calculated as the power related value Wasum(3) of the brightness category value x=3. The power related values Wasum(1), Wasum(2), Wasum(4) and Wasum(5) are also calculated in the same manner.

Then in S505, the power related value tTW(x) in FIG. 7 is calculated. For example, the power related value WUsum(5) of the brightness category value x=5 is 120, and the power related value Wasum(5) of the brightness category value x=5 is 25. Hence 120+25=145 is calculated as the power related value tTW(5). The power related values tTW(1), tTW(2), tTW(3) and tTW(4) are also calculated in the same manner.

Then in S506, the maximum value of the brightness category value x corresponding to the power related value tTW(x), that is not more than the threshold Wth, is detected. In the example in FIG. 7, the power related values tTW(1), tTW(2) and tTW(3) are not more than the threshold Wth=125, hence the brightness category value x=3 is detected. As a result, the correction value CG is determined so that the brightness threshold corresponding to the brightness category value x=3 is set. Thereby the second candidate relationship corresponding to the power related value tTW(3) is used as the brightness relationship. As a result, the power consumption of the display apparatus can be decreased to the power threshold or less, and display at a display brightness, that is approximately the same as the case of using the first candidate relationship, can be implemented in a region in which the data brightness Lin is not more than the data brightness Lout when the brightness category value x=3. In Example 2, it is assumed that the output of power to the subsequent stage (organic E1 panel 8) of the first correction unit 2 is not performed until the correction value CG is determined in S506. Thereby display can be performed at a power consumption that is not more than the power threshold.

As described above, the method of Example 2 can also determine the second candidate relationship when the power consumption corresponding to the first candidate relationship is more than the power threshold. Thereby the power consumption of the display apparatus can be reduced to the power threshold or less while maintaining display at an appropriate display brightness.

The method of determining the brightness relationship is not limited to the above method. For example, the brightness relationship setting unit 1 may set a brightness threshold corresponding to the brightness category value x of the power related value tTW(x), which is not the maximum value, out of at least two power related values tTW(x) that are not more than the threshold Wth. The brightness relationship setting unit 1 may set each of a plurality of candidate relationships as the brightness relationship, and acquire a plurality of brightness histograms corresponding to the plurality of candidate relationships respectively. Then the brightness relationship setting unit 1 may acquire a plurality of power related values tTW(x) using the plurality of brightness histograms. The brightness relationship setting unit 1 may acquire the power related value tTW(x) using the method of Example 1, for each of the plurality of candidate relationships. Further, the brightness relationship setting unit 1 may acquire the characteristic value from the input image data, not from the data brightness Lout acquired by the first correction unit 2.

### Example 3

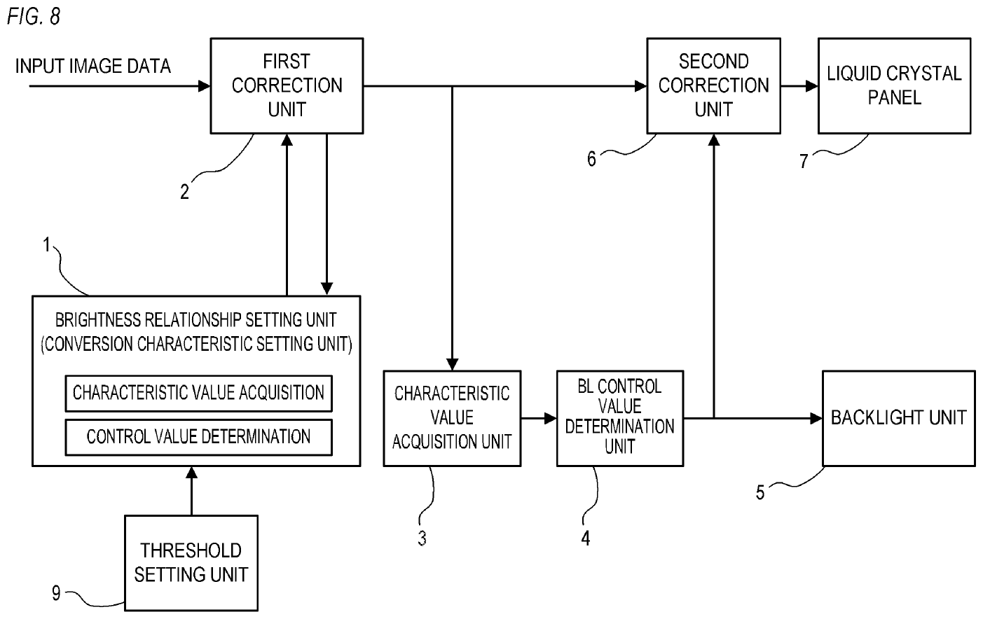

Example 3 of the present invention will be described. In the following, aspects (configuration, processing, etc.) that are different from Example 1 will be described, and aspects the same as Example 1 will be omitted. FIG. 8 is a block diagram depicting a configuration example of the display apparatus according to Example 3. In FIG. 8, a functional unit that same as Example 1 (FIG. 1) is denoted with the same reference sign as Example 1.

The threshold setting unit 9 sets a threshold Wth for the display apparatus in accordance with an operation by a user. In concrete terms, the threshold setting unit 9 outputs the threshold Wth in accordance with the operation by the user to the brightness relationship setting unit (conversion characteristic setting unit) 1. The brightness relationship setting unit 1 stores and uses the threshold Wth outputted from the threshold setting unit 9. In this way, according to Example 3, the threshold Wth is appropriately changed and used in accordance with the operation by the user.

As described above, according to Example 3, the threshold Wth (power threshold) is appropriately changed and used in accordance with the operation by the user. Thereby the power consumption can be decreased with certainty until the power consumption desired by the user is reached. The configuration of Example 3 is preferable in the case of extending the available time of the display apparatus that is driven by battery, for example. By the user operating to decrease the threshold Wth (power threshold), the available time of the display apparatus that is driven by battery can be extended.

### Example 4

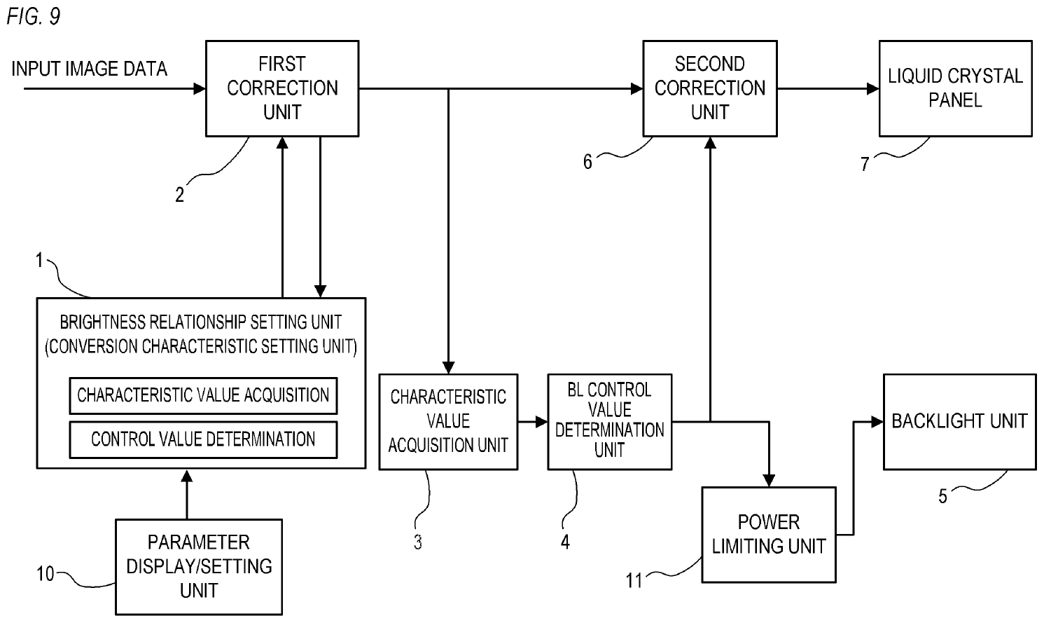

Example 4 of the present invention will be described. In the following, aspects (configuration, processing, etc.) that are different from Example 1 will be described, and aspects the same as Example 1 will be omitted. FIG. 9 is a block diagram depicting a configuration example of the display apparatus according to Example 4. In FIG. 9, a functional unit the same as Example 1 (FIG. 1) is denoted with the same reference sign as Example 1.

In Example 4, the first correction unit 2 uses the brightness relationship (gradation conversion characteristic) of the correction processing by the first correction unit 2 for the candidate relationship (gradation conversion characteristic candidate) in accordance with an operation performed by a user for the display apparatus. When the power consumption (power consumption of the display apparatus), corresponding to the current brightness relationship used by the first correction unit 2, is more than the power threshold, a power limiting unit 11 performs processing for the display with decreasing the display brightness at approximately the same ratio throughout the entire screen, so that the power consumption becomes not more than the power threshold. Hereafter the “display with decreasing the display brightness at approximately the same ratio through the entire screen so that the power consumption becomes not more than the power threshold” is referred to as the “limited display”.

In Example 4, the power limiting unit 11 determines the power consumption corresponding to the current brightness relationship used by the first correction unit 2, based on a plurality of BL control values outputted from the BL control value determination unit 4. If the determined power consumption is more than the power threshold, the power limiting unit 11 decreases the plurality of BL control values at the same ratio so that the power consumption becomes not more than the power threshold. Then the power limiting unit 11 outputs the decreased BL control values to the backlight unit 5. As a result, the light source unit of the backlight unit 5 emits light at a light emission brightness in accordance with the decreased BL control values, whereby the limiting display is performed. In Example 4, the BL control value is higher as the light emission brightness is higher, hence the “decrease of the BL control value” may be regarded as the “decrease of the light emission brightness”. In the case of using a self-emitting display apparatus, the limited display can be implemented by decreasing each pixel value of the display image data at a same ratio, for example. If the determined power consumption is not more than the power threshold, the power limiting unit 11 outputs the plurality of BL control values, which were outputted from the BL control value determination unit 4, to the backlight unit 5. As a result, the light source unit emits light at the light emission brightness in accordance with the BL control value outputted from the BL control value determination unit 4.

For example, when the total of the plurality of BL control values outputted from the BL control value determination unit 4 is more than the threshold Wth, the power limiting unit 11 determines that the power consumption corresponding to the current brightness relationship used by the first correction unit 2 is more than the power threshold. On the other hand, when the total of the plurality of BL control values outputted from the BL control value determination unit 4 is not more than the threshold Wth, the power limiting unit 11 determines that the power consumption corresponding to the current brightness relationship used by the first correction unit 2 is not more than the power threshold.

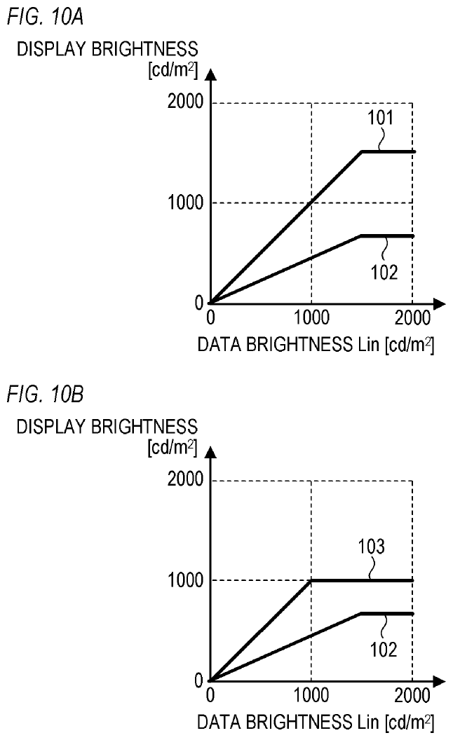

An example of an actual brightness relationship will be described with reference to FIG. 10A. The actual brightness relationship is a correspondence between the data brightness Lin and the actual display brightness confirmed by a user.

The reference sign 101 indicates the candidate relationship in accordance with the operation by the user, that is, the brightness relationship used by the first correction unit 2. When the power consumption corresponding to the brightness relationship 101 is not more than the power threshold, the limited display is not performed and the brightness relationship 101 becomes the actual brightness relationship. As a result, the pixels having a data brightness Lin that are not more than the brightness threshold (gradation threshold) of the brightness relationship 101 can be displayed at a display brightness that is approximately the same as the case of using the first candidate relationship.

When the power consumption corresponding to the brightness relationship 101 is more than the power threshold, the limited display is performed, and the brightness relationship 102 in which each display brightness of the brightness relationship 101 is decreased becomes the actual brightness relationship. As a result, the pixels having the data brightness Lin that are not more than the brightness threshold of the brightness relationship 101 cannot be displayed at the display brightness that is approximately the same as the case of using the first candidate relationship. However, the difference of the data brightness Lin can be displayed in a range of the data brightness Lin that is not more than the brightness threshold of the brightness relationship 101.

A parameter display/setting unit 10 determines the candidate relationship in accordance with the operation that the user performed for the display apparatus, and outputs the information on the determined candidate relationship to the brightness relationship setting unit (conversion characteristic setting unit) 1. Based on the information outputted from the parameter display/setting unit 10, the brightness relationship setting unit 1 determines the candidate relationship in accordance with the operation by the user. Then as the brightness relationship, the brightness relationship setting unit 1 sets the determined candidate relationship for the first correction unit 2.

In Example 4, the parameter display/setting unit 10 determines the brightness threshold in accordance with an operation by a user, and outputs the determined brightness threshold to the brightness relationship setting unit 1. Then the brightness relationship setting unit 1 sets the brightness threshold outputted from the parameter display/setting unit 10 to the first correction unit 2. As a result, a data brightness Lout that is the same as the data brightness Lin is corresponded to the data brightness Lin not more than the brightness threshold, and the brightness relationship, in which the data brightness Lout that is the same as the brightness threshold is corresponded to the data brightness Lin more than the brightness threshold, is used by the first correction unit 2.

The method of determining the candidate relationship in accordance with the operation by the user is not especially limited. For example, other parameters, such as the inclination of the display brightness with respect to the change of the data brightness Lin that is more than the brightness threshold, may be determined by the operation by the user.

The parameter display/setting unit 10 notifies the user on the information related to the candidate relationship in which the power consumption of the display apparatus becomes not more than the power threshold. Thereby the user can easily recognize the candidate relationship with which the power consumption becomes not more than the power threshold, and can easily perform operations to set the candidate relationship with which the power consumption becomes not more than the power threshold.

The candidate relationship in which the power consumption of the display apparatus becomes not more than the power threshold can be determined based on the power related value or the correction value CG, for example. In Example 4, it is assumed that the upper limit Lmax of the data brightness Lin is 2000 cd/m². If the correction value CG=0 is determined by the method of Example 1, the range of 0 cd/m² to 2000 cd/m² can be determined as the brightness threshold range in which the power consumption of the display apparatus becomes not more than the power threshold. In this case, the parameter display/setting unit 10 notifies the user on the information which indicates the range of 0 cd/m² to 2000 cd/m², for example. Thereby the user can easily recognize the range of the brightness threshold in which the power consumption becomes not more than the power threshold, and can easily perform operations to set the brightness threshold with which the power consumption becomes not more than the power threshold.

Further, the parameter display/setting unit 10 notifies the user on information on the current brightness relationship used by the first correction unit 2. Thereby the user can easily recognize the current brightness relationship used by the first correction unit 2, and can easily perform operations to update the actual brightness relationship to a desired candidate relationship.

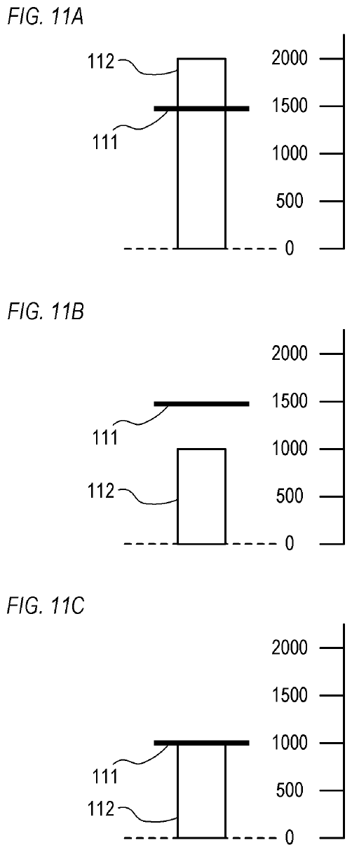

The information is notified to the user by image display, voice output or lighting of a lamp, for example. In Example 4, the information is notified to the user by displaying such graphic images as illustrated in FIG. 11A to FIG. 11C. In FIG. 11A to FIG. 11C, the line 111 indicates the brightness threshold in accordance with the operation by the user, that is, the brightness threshold of the brightness relationship that is used by the first correction unit 2. The bar 112 indicates the range of the brightness threshold with which the power consumption becomes not more than the power threshold.

In FIG. 11A, the line 111 indicates 1500 cd/m², and the bar 112 indicates a range not more than 2000 cd/m². In this case, the limited display is not performed since 1500 cd/m² is lower than 2000 cd/m², and the candidate relationship in accordance with the operation by the user becomes an actual brightness relationship. In concrete terms, the brightness relationship 101 in FIG. 10A becomes an actual brightness relationship. The bar 112 does not mean that a pixel having the data brightness Lin that is not more than 2000 cd/m² exists. Therefore the maximum brightness of the data brightness Lin included in the input image data, may be additionally notified to the user.

In FIG. 11B, the line 111 indicates 1500 cd/m², and the bar 112 indicates a range not more than 1000 cd/m². In this case, the limited display is performed since 1500 cd/m² is higher than 1000 cd/m², and the brightness relationship determined by decreasing each display brightness of the candidate relationship in accordance with the operation by the user becomes the actual brightness relationship. In concrete terms, the brightness relationship 102 in FIG. 10A becomes the actual brightness relationship.

By visually checking the bar 112 in FIG. 11B, the user can easily recognize that the limited display is not performed if the brightness threshold that is not more than 1000 cd/m² is set. When the user performs an operation to update the brightness threshold to 1000 cd/m², the brightness threshold of the brightness relationship that is used by the first correction unit 2 is updated to 1000 cd/m². As a result, the limited display is not performed, and the candidate relationship in accordance with the operation by the user becomes the actual brightness relationship. In concrete terms, the brightness relationship 103 in FIG. 10B becomes the actual brightness relationship.

By updating the brightness threshold from 1500 cd/m² to 1000 cd/m², the range of the data brightness Lin, in which the difference of the data brightness Lin can be displayed, is decreased from the range that is not more than 1500 cd/m² to the range that is not more than 1000 cd/m². However, pixels having the data brightness Lin that are not more than 1000 cd/m² can be displayed at a display brightness that is approximately the same as the case of using the first candidate relationship.

Thus, by performing the operation to update the brightness threshold, the user can select between: a display in which the range of the data brightness Lin is wide and with which the difference of data brightness Lin can be expressed; and a display at a display brightness that is approximately the same as the case of using the first candidate relationship can be implemented.

Further, by updating the brightness threshold from 1500 cd/m² to 1000 cd/m², the graphic image is updated from the graphic image in FIG. 11B to the graphic image in FIG. 11C. Thereby the user can easily recognize such information as to whether the limited display is being performed or not.

As described above, according to Example 4, information on the candidate relationship with which the power consumption of the display apparatus becomes not more than the power threshold is notified to the user. Thereby the user-friendliness of the display apparatus can be improved. For example, the user can easily perform the operation to acquire various desired brightness relationships as the actual brightness relationship. The various brightness relationships are, for example, the brightness relationship in which the range of the data brightness Lin is wide and with which the difference of the data brightness Lin can be expressed; and the brightness relationship with which a display at a display brightness that is approximately the same as the case of using the first candidate relationship can be implemented.

The graphic image for notification is not limited to the graphic images in FIG. 11A to FIG. 11C. For example, an icon, text image and so on may be used instead of at least one the line 111 and the bar 112. In concrete terms, such a text image as “current brightness threshold is 1000 cd/m²” or “brightness of entire screen will drop if brightness threshold exceeding 1500 cd/m² is set” may be used.

Each functional unit of Examples 1 to 4 may or may not be independent hardware. Functions of at least two functional units may be implemented by common hardware. Each of a plurality of the functions of one functional unit may be implemented by independent hardware. At least two functions of one functional unit may be implemented by common hardware. Each functional unit may or may not be implemented by hardware. For example, the apparatus may include a processor and a memory storing control programs. Then the functions of at least a part of the functional units of the apparatus may be implemented by the processor reading the control programs from memory and executing the programs.

Examples 1 to 4 are merely examples, and configurations implemented by appropriately modifying or changing the configurations of Examples 1 to 4 within the scope of the essence of the present invention are included in the present invention. Configurations implemented by appropriately combining the configurations of Examples 1 to 4 are also included in the present invention.

According to the present invention, the power consumption of the display apparatus can be decreased while maintaining display at an appropriate display brightness.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A display apparatus comprising:
a display panel; and
at least one memory and at least one processor which function as:
a setting unit configured to set a conversion characteristic for input image data; and
a correction unit configured to generate corrected image data by performing correction processing on the input image data in accordance with the conversion characteristic that is set, wherein
the display panel displays an image based on the generated corrected image data, and
the setting unit acquires a power related value, which is a value related to a power consumption of the display apparatus, based on the input image data and a first conversion characteristic that is set, and in a case where the acquired power related value is greater than a first threshold, the setting unit changes the setting to a second conversion characteristic of decreasing data brightness of the corrected image data, which corresponds to data brightness of the input image data that is higher than a second threshold, from that in a case where the acquired power related value is smaller than the first threshold.

2. The display apparatus according to claim 1, wherein the second conversion characteristic is a conversion characteristic to set data brightness of the corrected image data, which corresponds to data brightness of the input image data that is lower than the second threshold, to be the same as the data brightness of the input image data.

3. The display apparatus according to claim 1, wherein the second conversion characteristic is a conversion characteristic to set the data brightness of the corrected image data, which corresponds to the data brightness of the input image data that is higher than the second threshold, to a constant value.

4. The display apparatus according to claim 3, wherein the second threshold is smaller as the power related value is greater than the first threshold.

5. The display apparatus according to claim 1, wherein the setting unit determines the second conversion characteristic by determining an inclination of a change of an output value with respect to a change of an input value that is greater than the first threshold.

6. The display apparatus according to claim 5, wherein the inclination is smaller as the power related value is greater than the first threshold.

7. The display apparatus according to claim 1, wherein the setting unit acquires a power related value, which is a value related to the power consumption of the display apparatus, based on the input image data and the second conversion characteristic that is set, and in a case where the acquired power related value is greater than the first threshold, the setting unit updates the second conversion characteristic so that the power consumption of the display apparatus is further decreased.

8. The display apparatus according to claim 1, wherein the setting unit acquires a plurality of power related values which correspond to a plurality of conversion characteristic candidates respectively, and determines any of the plurality of conversion characteristic candidates as the second conversion characteristic.

9. The display apparatus according to claim 1, wherein the setting unit sets the first threshold in accordance with a user operation.

10. The display apparatus according to claim 1, wherein the power related value is a value based on light emission brightness of the display panel.

11. The display apparatus according to claim 10, further comprising a light-emitting unit which includes a plurality of light source units, wherein
the display panel displays the image by modulating light emitted from the light-emitting unit,
each of the plurality of light source units emits light with an independent light emission brightness based on the corrected image data, and
the setting unit acquires a value based on a plurality of light emission brightness, which correspond to the plurality of light source units respectively, as the power related value.

12. The display apparatus according to claim 11, wherein the setting unit acquires a value, which is based on total brightness or average brightness of the plurality of light emission brightness, as the power related value.

13. The display apparatus according to claim 1, wherein the display panel is a self-emitting display panel.

14. The display apparatus according to claim 1, wherein the power related value is a value based on data brightness of each of a plurality of pixels of the input image data.

15. A display method comprising:
a setting step of setting a conversion characteristic for input image data;
a correction step of generating corrected image data by performing correction processing on the input image data in accordance with the conversion characteristic that is set; and
a display step of displaying an image based on the generated corrected image data, wherein
in the setting step, a power related value, which is a value related to a power consumption of the display apparatus, is acquired based on the input image data and a first conversion characteristic that is set, and in a case where the acquired power related value is greater than a first threshold, the setting is changed to a second conversion characteristic of decreasing data brightness of the corrected image data, which corresponds to data brightness of the input image data that is higher than a second threshold, from that in a case where the acquired power related value is smaller than the first threshold.

16. A non-transitory computer readable medium that stores a program, wherein
the program causes a computer to execute a display method comprising:
a setting step of setting a conversion characteristic for input image data;
a correction step of generating corrected image data by performing correction processing on the input image data in accordance with the conversion characteristic that is set; and
a display step of displaying an image based on the generated corrected image data, and
in the setting step, a power related value, which is a value related to a power consumption of the display apparatus, is acquired based on the input image data and a first conversion characteristic that is set, and in a case where the acquired power related value is greater than a first threshold, the setting is changed to a second conversion characteristic of decreasing data brightness of the corrected image data, which corresponds to data brightness of the input image data that is higher than a second threshold, from that in a case where the acquired power related value is smaller than the first threshold.
